(19) United States
(12) Patent Application Publication
(10) Pub. No.: US 2005/0186388 A1
(43) Pub. Date: Aug. 25, 2005

(54) AUTOMOTIVE INTERIOR TRIM ASSEMBLY WITH SOFT FEEL

(76) Inventors: David E. Mekas, Lincoln Park, MI (US); Kevin P. Visger, Commerce Township, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/708,315

(22) Filed: Feb. 24, 2004

(51) Int. Cl. B32B 3/10

(52) U.S. Cl. 428/116

(57) ABSTRACT

An automotive interior trim assembly provides areas having a soft feel without requiring padding to be added to the trim assembly. The trim assembly comprises a substrate member having apertures formed in a target area for providing the soft feel, and a flexible skin disposed over the substrate member. The flexible skin contacts the substrate member, at least in the target area, so that the skin may be deformed under the application of a force. In one embodiment, the trim assembly is formed in a two-shot molding process, wherein a first material is injected to form the substrate during the first shot, and a second material is injected to form the flexible skin during the second shot.

### FIELD OF THE INVENTION

The present invention pertains generally to automotive interiors and more particularly to trim assemblies for automotive interiors.

### BACKGROUND OF THE INVENTION

It is known to provide automotive interiors with various trim assemblies to enhance the aesthetic appearance of the automotive interior and to provide comfort and convenience to vehicle occupants. Examples of these interior trim assemblies include instrument panels, armrests, door trim panels, and consoles. To increase the aesthetic appearance of the trim assemblies and to improve the comfort and convenience to vehicle occupants, it is often desired to form at least portions of the trim assemblies with areas which are soft to the touch. Typically, these soft-feel areas have been formed by providing a resilient padding material beneath a pliable surface layer such as leather, vinyl, or fabric material.

One conventional method of forming trim assemblies with padded material includes injecting foam material between a rigid substrate and a skin layer joined to the substrate. In another conventional method, a preformed, soft, resilient pad is secured to a rigid plastic shell and a pliable skin layer is stretched over the pad and secured to the shell to form the trim assembly. These prior methods are generally costly due to the multiple components and manufacturing steps required to make the padded trim assemblies.

Various other trim assemblies have been manufactured using a two-shot molding process wherein a relatively soft skin layer is formed over a hard substrate material without padding. However, the trim panels produced by two-shot molding are still relatively hard and unforgiving, compared to trim assemblies having foam layers and pads, and thus lack the improved aesthetics and comfort provided by padded trim assemblies. In an effort to improve the feel of non-padded trim assemblies, skin layers having bumps or nibs formed on the back surface of the skin layers have been applied over rigid substrates. The nibs raise the skin layer slightly away from the rigid substrate to create “soft” areas which deform when a force is applied to the trim assembly. While these nibbed trim assemblies offer a compromise between two-shot molded trim assemblies and padded trim assemblies, they are still more costly than two-shot molded assemblies due to the fact that the skin layer must be manufactured separately in order to create the bumps or nibs. A need therefore exists for an automotive trim assembly which provides a soft feel while further reducing manufacturing costs.

### SUMMARY OF INVENTION

The present invention provides a non-padded automotive interior trim assembly that exhibits a soft-feel. The trim assembly may be formed as an instrument panel, an armrest, a console, a door panel, or other interior components of an automobile. In one embodiment, the trim assembly comprises a substrate member having at least one target area for providing a soft feel, and a flexible skin disposed over the substrate member and contacting the substrate member at least in the target area. Apertures are formed in the target area of the substrate member, whereby the flexible skin may be deformed under application of force to provide the soft feel.

In another embodiment, the trim assembly is formed in a two-shot molding process. A first material is injected into a mold during the first shot to form a substrate member having apertures in a target area for providing a soft feel to the trim assembly. A second material is injected into the mold during the second shot to form a flexible skin over the substrate member, wherein the skin layer contacts the substrate member at least in the target area.

The features and objectives of the present invention will become more readily apparent from the following Detailed Description taken in conjunction with the accompanying drawings.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary automotive interior trim assembly according to the present invention, in the form of an armrest;

FIG. 1A is a perspective view of another embodiment of an armrest according to the present invention;

FIG. 2 is a cross-sectional view of the armrest of FIG. 1, taken along line 2-2;

FIG. 2A is a cross-sectional view of the armrest of FIG. 1A, taken along line 2A-2A; and

FIG. 2B is a cross-sectional view of an armrest similar to FIG. 2 and depicting another embodiment according to the present invention.

### DETAILED DESCRIPTION

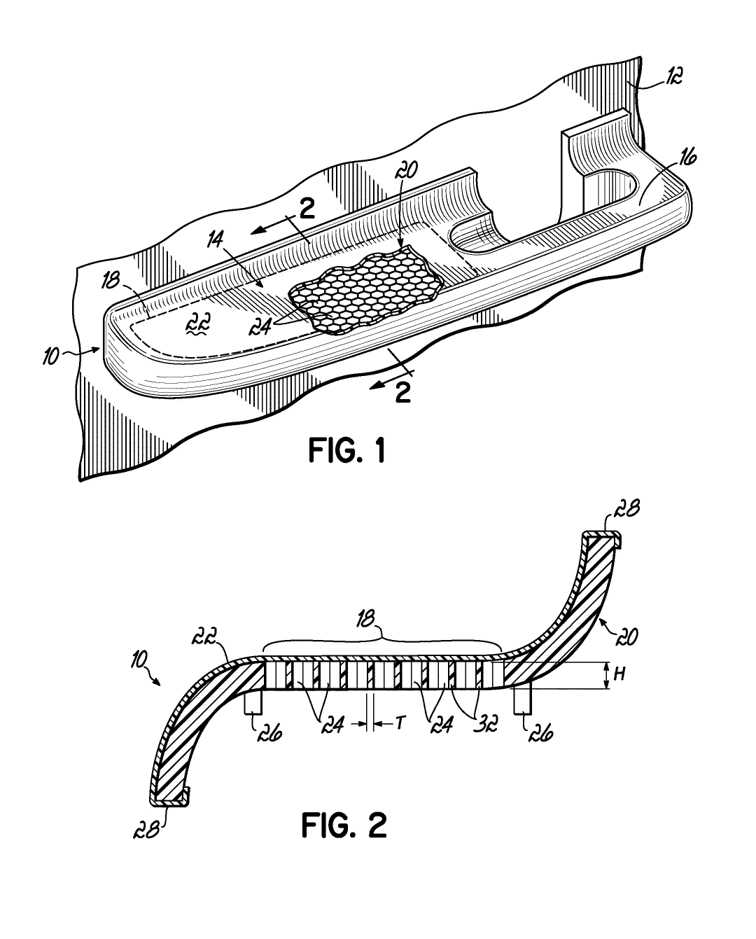

Referring to FIG. 1, there is shown an exemplary automotive interior trim assembly of the present invention, in the form of an armrest 10. The armrest 10 is attached to a vertical panel 12 within the interior of an automobile, such as a door panel. In the embodiment shown, the armrest 10 includes a first portion 14 providing a horizontal surface upon which a vehicle occupant may rest their arm.

The armrest 10 may further include a handle portion 16 configured for grasping by a vehicle occupant to facilitate, for example, closing the door to which the armrest 10 is attached. The first portion 14 of the armrest 10 includes an area 18 in which it is desired to provide a soft feel.

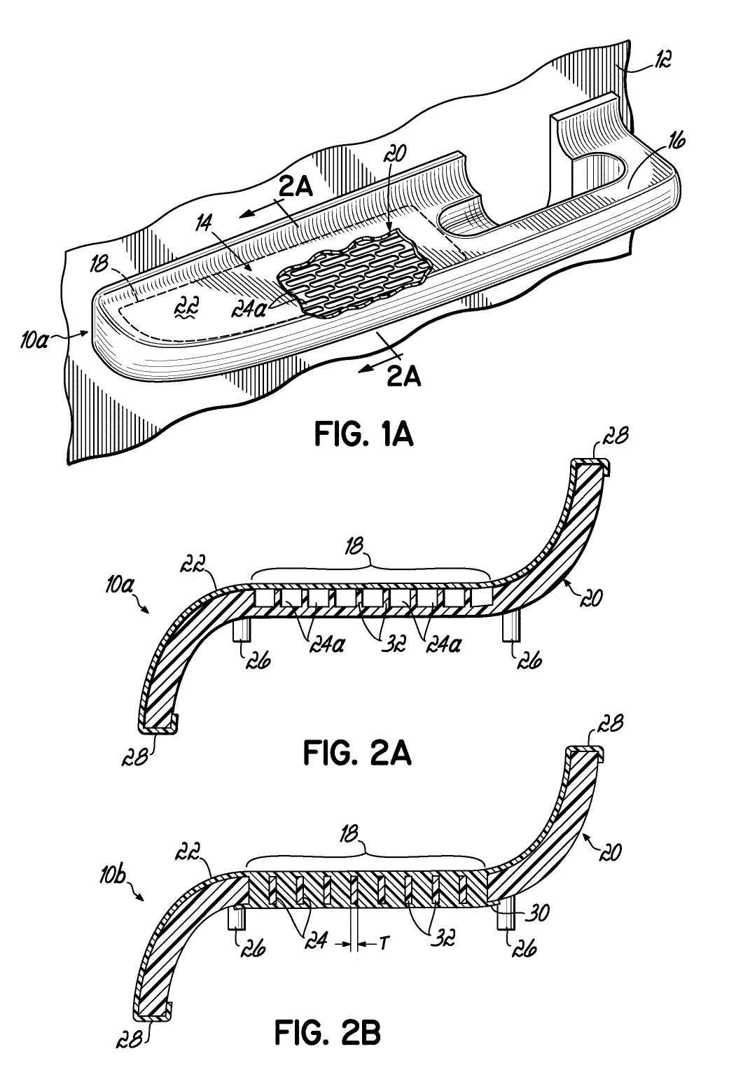

With continued reference to FIG.1, and referring further to FIG. 2, the armrest 10 of the present invention includes a rigid substrate member 20 which forms at least a part of the structural support of the armrest 10. A flexible skin layer 22 is disposed over the substrate member 20. To provide the soft feel in the target area 18, honeycomb-shaped apertures 24 are formed in the substrate member 20.

While the apertures 24 are depicted as being formed through the substrate number 20, it will be recognized that the apertures 24 may alternatively be formed as blind holes that do not pass completely through the substrate member 20. Moreover, the apertures 24 may be formed in various shapes and configurations other than the honeycomb configuration shown herein. For example, the apertures 24 may more specifically comprise square, round, or slotted holes or recesses, or any other type of hole or recess suitable for allowing the flexible skin layer 22 to deform under an applied force, as described below. FIG. 1A, for example, depicts another embodiment of an armrest 10a, according to the present invention, wherein apertures 24a comprise slots formed into the substrate member 20. In FIG. 2A, it is seen that the apertures 24a do not extend through substrate member 20, but are formed as blind holes.

The flexible skin layer 22 is disposed directly over the substrate member 20 and is in contact with the surface of the substrate member 20. Advantageously, the apertures 24 and the target area 18 provide resilience to the target area 18 by permitting the flexible skin layer 22 to deform under an applied force, thereby providing a soft feel to the target area 18 of the armrest 10.

The substrate member 20 may further include ribs or tabs 26 integrally formed thereon to provide strength to the substrate member 20 or to facilitate securing the substrate member 20 to the vertical panel 12. In FIG. 2, the peripheral edges 28 of the skin layer 22 are shown wrapped around corresponding edges of the substrate member 20, however, it will be recognized that the skin layer 22 may alternatively be formed to encase the entire substrate member 20.

In the embodiments depicted in FIGS. 1, 2, and 2A, skin layer 22 extends across apertures 24, 24a. It will be recognized, however, that the material forming the skin layer 22 may alternatively fill, or partially fill, some or all of the apertures 24, 24a, as depicted in FIG. 2B. When the apertures 24 are formed through substrate member 20, a secondary skin layer 30 may be formed on the opposing side of the substrate member 20. Advantageously, filling apertures 24, 24a and forming the secondary skin layer 30 helps to ensure that skin layer 22 is firmly secured to the substrate member 20 and inhibits shifting of the skin layer 22 over the substrate member 20 which might otherwise degrade the aesthetic feel of the armrest 10. Moreover, selective filling of the apertures 24, 24a enables the feel of the armrest 10 to be tuned to a desired softness. With reference to FIG. 2, the feel of the armrest 10 may also be selectively tuned to a desired softness by varying the height H and/or thickness T of those portions of substrate member 20 defining wall sections 32 between apertures 24, 24a.

Advantageously, an interior trim assembly of the present invention, such as armrest 10, may be formed in a two-shot molding process wherein the first shot forms the rigid substrate member 20 and the second shot forms the flexible skin layer 22. The substrate member 20 may be formed from thermoplastic olefin, acrylonitrile butadiene styrene, styrene maleic anhydride, polycarbonate/acrylonitrile butadiene styrene alloy, or other materials suitable for molding the rigid substrate member 20. The skin layer 22 may be formed from vinyl, thermoplastic elastomer, or other suitable materials for forming a flexible skin over the substrate member 20.

While the exemplary interior trim assembly has been shown and described herein in the form of an armrest 10, it will be recognized that the trim assembly may alternatively be provided in the form of other interior components, such as instrument panels or dashboards, consoles, door panels, or various other automotive trim components.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. An automotive interior trim assembly for an automobile, comprising:
a substrate member forming at least part of a structural support of the trim assembly and including a least one target area for providing a soft feel to the trim assembly;
a plurality of apertures formed in said substrate member within said target area; and
a flexible skin disposed directly over and contacting said substrate member, at least proximate said target area.

2. The trim assembly of claim 1, wherein said plurality of apertures are formed in a generally honeycomb pattern.

3. The trim assembly of claim 1, wherein said plurality of apertures are formed through said substrate member.

4. The trim assembly of claim 1, wherein said plurality of apertures are blind holes formed into said substrate member.

5. The trim assembly of claim 1, wherein said plurality of apertures comprise slots formed through said substrate member.

6. The trim assembly of claim 1, wherein said substrate member is formed from an injection moldable polymer.

7. The trim assembly of claim 1, wherein said skin comprises vinyl.

8. The trim assembly of claim 1, wherein at least some of said apertures are at least partially filled with a material which forms said flexible skin.

9. A method of forming an automotive interior trim assembly in a two-shot molding operation, comprising:
injecting a first material to form a substrate member having apertures in a target area for providing a soft-feel to the trim assembly; and
injecting a second material to form a pliable skin layer over the substrate member, the skin layer contacting the substrate member at least in the target area.

10. The method of claim 9, wherein the injecting step further comprises forming apertures through the substrate.

11. The method of claim 9, wherein the injecting step further comprises forming the apertures as blind holes.

12. The method of claim 9, further comprising:filling at least some of the apertures at least partially with the second material.
